(19) United States
(12) Patent Application Publication
(10) Pub. No.: US 2024/0399781 A1
(43) Pub. Date: Dec. 5, 2024

(54) SECURITY ELEMENT FOR VALUE DOCUMENTS OR SECURITY DOCUMENTS

(71) Applicant: Hueck Folien Gesellschaft m.b.H., Baumgartenberg (AT)

(72) Inventors: Anita FUCHSBAUER, Linz (AT); Martin EGGINGER, Linz (AT); Stephan TRASSL, Baumgartenberg (AT)

(21) Appl. No.: 18/687,491

(22) PCT Filed: Aug. 29, 2022
(86) PCT No.: PCT/AT2022/060294

§ 371 Date: Feb. 28, 2024

(30) Foreign Application Priority Data
Aug. 30, 2021 (EP) 21193858.4

(51) Int. Cl. B42D 25/36; B42D 25/29

(52) U.S. Cl. CPC B42D 25/36; B42D 25/29

(57) ABSTRACT

A security element for value documents or security documents comprises at least one security feature, wherein the security element comprises at least one recycled material, and/or at least one material made of renewable raw materials, and/or at least one biologically degradable and/or marine-degradable material. Polymer substrates, value documents, and security documents for such security elements are also disclosed.

### RELATED APPLICATIONS

This is a national stage under 35 U.S.C. § 371 of International Application No. PCT/AT2022/060294, filed Aug. 29, 2022, which claims priority of European Patent Application No. 21193858.4, filed Aug. 30, 2021.

### TECHNICAL FIELD

The field of this disclosure relates to a security element, a polymer substrate and a value document or security document.

### BACKGROUND

Every year, billions of new banknotes are printed worldwide and old banknotes are withdrawn from circulation. Banknotes either consist of a polymer substrate and/or contain security elements in the form of security threads, transfer threads, strips and/or patches, which essentially consist of a polymer carrier film and security features (e.g. magnetic coding, embossing varnish layers, metallized layers, colour shifting materials or layers, etc.). Paper banknotes are usually either sent for thermal recycling, composted or processed in a recycling or downcycling process, for example into insulating materials. Polymer banknotes are either thermally recycled or processed into plastic products in a recycling or downcycling process.

In line with the global trend towards sustainable products, biologically degradable cellulose fiber based security elements and biologically degradable cellulose fiber based polymer banknotes have become known to experts for example from WO2020152505A1 and WO2020156655A1.

### SUMMARY

A need remains for security elements that overcome the remaining disadvantages of the prior art and further improve the sustainability of security elements, polymer substrates and value documents or security documents, which also guarantee a high degree of counterfeit protection.

In the present context, value documents and security documents are understood to mean in particular banknotes, passports, ID cards and ID documents, tickets for public transport and for events, securities, etc. The term “paper” is to be understood colloquially and defines less the material used than the resulting form of the document. Unless explicitly stated in this document, the term value document or security document therefore always refers to both cellulose fiber based value documents or security documents, such as paper banknotes, and polymer value documents or polymer security documents, such as polymer banknotes. Polymer value documents or polymer security documents usually comprise polymer substrates, which serve as a carrier material for security elements, various functional layers and print layers, for example. However, polymer substrates may also be useful in the structure of safety elements, where they can also act as a carrier material.

Security elements with at least one security feature are generally known to experts. For example, security elements may be threads, strips, patches, transfer films or even overlay films for passports and ID cards, for example. Security elements may be made up of one or more layers or one or more films. The term “layer” may describe a single layer as well as a composite or a layering of several layers. These may be several layers of the same type, for example, but also several different layers. It should be noted at this point that one or more intermediate layers may be arranged between the layers described in this document. It is therefore not absolutely necessary for the layers described to contact each other. It should also be noted that the term “layer” in this document is to be understood as meaning that a layer may also be made up of several sub-layers. The same applies to the term “film”.

It should also be noted that the term “in particular” in this document is understood to mean a possible more specific embodiment or more detailed specification of an object, but does not necessarily have to represent a mandatory, preferred embodiment thereof or a mandatory approach.

As used herein, the terms “comprising”, “has”, “having”, “includes”, “including”, “contains”, “containing” and any variations thereof are intended to cover non-exclusive inclusion.

The present disclosure relates to a security element for value documents or security documents with at least one security feature. It is provided that the safety element comprises at least one recycled material and/or at least one material made of renewable raw materials and/or at least one biologically degradable and/or marine-degradable material.

Security features increase protection against counterfeiting and serve to certify the authenticity of security elements, i.e. value documents and security documents.

The at least one recycled material may be any type of recyclable material or material composition. For example, this includes any type of plastic, as well as metals, metal alloys or metal compounds. Various chemical compositions may also be recyclable and thus be included in the security element as recycled material. Because security elements are usually made up of several layers, films or components, it may be useful if different types of recycled material are used in these individual components.

This improves the sustainability of the security element and its entire product life cycle, as the use of at least one recycled material enables the sustainable production of counterfeit-proof security elements. By using at least one recycled material in the production of security elements, means are created which meet the increasing ecological requirements and at the same time guarantee the necessary counterfeit protection.

The sustainable life cycle of the security element may be further improved by the alternative or additional use of at least one material made of renewable raw materials and/or biologically degradable and/or marine-degradable material. It may also make a valuable contribution to environmental protection. The material made of renewable raw materials or the biologically degradable and/or marine-degradable material may be a material other than the recycled material. However, it is particularly sustainable if the material made of renewable raw materials or the biologically degradable and/or marine-degradable material is the same material as the recycled material.

Renewable raw materials may be used for the synthesis of the corresponding chemical raw materials. Plastics may, for example, be divided into so-called drop-ins and new bio-based plastics. Drop-ins are bioplastics that are based on renewable raw materials and for which existing processes and value chains remain essentially unchanged during processing, use and recycling (e.g. PA, PU, PE, PP, PET, etc.). New bio-based plastics are replacing fossil-based plastics (e.g. thermoplastic starch (TPS), polylactic acid (PLA), cellulose- or lignin-based plastics, etc.), although their use as an alternative to fossil-based plastics is not yet fully established for all bio-based plastics.

Biologically degradable plastics consist of polymers that can be decomposed by microorganisms under certain conditions. The term “marine-degradable” refers to the possibility of natural degradation under marine environmental conditions. Biologically degradable and bio-based plastics include polyhydroxyalkanoates (PHA) and thermoplastic starch (TPS), for example. Biologically degradable plastics include, for example, polylactic acid (PLA), polycaprolactone (PCL), polybutylene succinate (PBS) and polybutylene adipate terephthalate (PBAT).

Furthermore, it may be useful if the safety element comprises at least 10%, preferably at least 20%, particularly preferably at least 30%, in particular at least 50% of the at least one recycled material and/or the at least one material made of renewable raw materials and/or the at least one biologically degradable and/or marine-degradable material, or if the safety element comprises at least 10%, preferably at least 20%, particularly preferably at least 30%, in particular at least 50% of several recycled materials and/or several materials made of renewable raw materials and/or several biologically degradable and/or marine-degradable materials.

Furthermore, it may be provided that the at least one recycled material, and/or the at least one material made of renewable raw materials, and/or the at least one biologically degradable and/or marine-degradable material is a cellulose fiber free material.

In addition, it may be provided that the safety element is formed with at least one plastic film comprising the at least one recycled material and/or the at least one material made of renewable raw materials and/or the at least one biologically degradable and/or marine-degradable material. This may be, for example, a polymer carrier film or a polymer substrate to which the at least one security feature and, if necessary, other layers such as protective varnishes, heat-sealing varnishes, adhesives, etc. may be applied. If the plastic film is a polymer substrate, it may advantageously be formed according to any of the claims.

An embodiment according to which it may be provided that the at least one recycled material and/or the at least one biologically degradable and/or marine-degradable material comprises a chemically recycled plastic and/or a mechanically recycled plastic, in particular comprises a translucent recycled plastic, is also advantageous, wherein the at least one recycled material and/or the at least one biologically degradable and/or marine-degradable material preferably comprises at least one material from the group consisting of polyimide (PI), polypropylene (PP), monoaxially oriented polypropylene (MOPP) biaxially oriented polypropylene (BOPP), polyethylene (PE), polyphenylene sulfide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF), ethylene tetrafluoroethylene hexafluoropropylene fluorterpolymer (EFEP), cellulose- or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or mixtures and/or co-polymers and/or composites of these materials or is made from at least one of these materials.

Chemical recycling refers to methods in which plastics are broken down into shorter molecules by thermal or energy effects or by chemical processes so that they can be reused in subsequent manufacturing processes such as polymerization. So-called PCR plastics (“post consumer recycling”), PIR plastics (“post industrial recycling”) and CCU plastics (“carbon capture and utilization”), for example, may be chemically recycled.

For the production of PCR plastics, plastic waste is converted back into raw materials or monomers for the production of new raw materials after end use and used to produce polymer films or varnish components, for example. For example, PET, PE and PP films may be sourced with a certain proportion of PCR raw materials. The production of PIR plastics is generally similar to the production of PCR plastics. However, industrial waste is used here, which is generally less contaminated or more homogeneous. To produce CCU plastics, carbon dioxide is separated from exhaust gas streams or from the air and then serves as a raw material or component for the production of energy sources such as methane or methanol or for the production of chemical raw materials such as polycarbonates or PVC. Both chemical and biological methods with algae or microorganisms are known for this purpose.

Mechanically recycled plastic may be recovered in the course of material recycling. Among other things, PCR plastics and PIR plastics may be mechanically recycled. Plastic waste is sorted according to the respective type of plastic and processed into recyclates, which can be used as a starting material for new products and thus replace plastics made from new materials. This type of recycling preserves the original chemical structure of the polymers.

According to a further embodiment, it is conceivable that the at least one recycled material and/or the at least one biologically degradable and/or marine-degradable material is at least one recycled metallic material, in particular selected from the group consisting of silver, copper, aluminum, gold, platinum, niobium, tin, or nickel, titanium, vanadium, chromium, cobalt and palladium or alloys of these materials, in particular cobalt-nickel alloys, and/or at least one highly refractive dielectric material with a refractive index of greater than 1.65, in particular selected from the group consisting of zinc sulphide (ZnS), zinc oxide (ZnO), titanium dioxide (TiO2), carbon (C), indium oxide (In2O3), indium tin oxide (ITO), tantalum pentoxide (Ta2O5), cerium oxide (CeO2), yttrium oxide (Y2O3), europium oxide (Eu2O3), iron oxides such as iron (II,III) oxide (Fe3O4) and iron (III) oxide (Fe2O3), hafnium nitride (HfN), hafnium carbide (HfC), hafnium oxide (HfO2), lanthanum oxide (La2O3), magnesium oxide (MgO), neodymium oxide (Nd2O3), praseodymium oxide (Pr6O11), samarium oxide (Sm2O3), antimony trioxide (Sb2O3), silicon carbide (SiC), silicon nitride (Si3N4), silicon monoxide (SiO), selenium trioxide (Se2O3), tin oxide (SnO2), tungsten trioxide (WO3), highly refractive organic monomers and/or highly refractive organic polymers or layers of metal oxides, such as non-stoichiometric aluminum oxide, copper oxides, or chromium oxides and/or is produced from at least one recycled metallic material from printing inks or varnishes with metallic pigments, in particular selected from the group of aluminum, silver, copper, gold, platinum, niobium, tin, or from nickel, titanium, vanadium, chromium, cobalt and palladium or alloys of these materials, in particular cobalt-nickel alloys.

The use of sustainable raw materials for various coating materials (e.g. paint components, metals such as aluminum from recycled aluminum, etc.) has made it possible to produce sustainable security elements.

Security features increase protection against counterfeiting and serve to certify the authenticity of security elements, i.e. value documents and security documents. It may be expedient if the at least one security feature is formed by an embossed layer, a partially metallized layer, a fluorescent layer, a printed layer, a magnetic coding and/or an optically variable and/or optically effective feature, in particular by a hologram and/or a color shifting coating, for example a coating comprising at least one color shifting thin layer element, and/or by features that are optically recognizable in transmission or reflection, machine-readable features (i.e. a magnetic coding) and/or by electromagnetic wave-absorbing and/or re-emitting substances or features. The at least one security feature may also be formed by luminescent or phosphorescent coatings. Experts are also familiar with the classification of security features into three levels. Level 1 comprises security features that are visible to an observer, such as holograms, watermarks, security threads, etc. Level 2 comprises covert security features, i.e. security features that are not visible to an observer without aids, such as fluorescent features, infrared-visible features, microprinting, machine-readable features, etc. Level 3 comprises forensically detectable features or features that require special methods or tools for their detection, such as nano-optical structures or biochemical characteristics.

Optically variable and/or optically effective security features or level 1 security features also include, for example, optically effective relief structures, in particular mirrors, diffraction gratings, holograms, kinoforms, asymmetric diffraction structures, matte structures, in particular anisotropic matte structures, blaze gratings, zero-order diffraction structures, Fresnel-like free-form surfaces, plasmonic structures, reflective structures, in particular micromirror arrangements, light-refracting or focusing structures, in particular microlens arrangements, volume holograms and color shifting effects (based on thin-film elements, liquid crystals, color shifting pigments, etc.).

In addition, it may be provided that the at least one security feature comprises an optically variable security feature, and that the at least one plastic film comprises a PET film, which PET film is made with at least 50% PCR material. In this case, for example, the safety element may also be configured as a safety thread. The security feature may be a color shifting thin layer structure, for example.

Furthermore, it may be provided that the security element is produced with an optically variable embossing in an embossing varnish with at least 20% acrylate monomers from renewable raw materials. For example, bio-based and biologically degradable embossing varnishes based on PLA may be used here. Thermoplastic polymers such as polymethyl methacrylate (PMMA), acrylates, PVC, polyurethane (PU) or similar materials, or radical or cationic curing UV coatings based on polyester, PU or acrylate binders are also suitable as materials for the embossing varnishing layer. For example, the security element may be a transfer film.

The present disclosure also relates to a polymer substrate for the production of polymer value documents or polymer security documents or for the production of security elements. It is provided that the polymer substrate comprises at least one recycled material and/or at least one material made of renewable raw materials and/or at least one biologically degradable and/or marine-degradable material.

The at least one recycled material may be any type of recyclable material or material composition. For example, this includes any type of plastic, as well as metals, metal alloys or metal compounds. Various chemical compositions may also be recyclable and thus be included in the security element as recycled material. If the polymer substrate is made up of several layers, films or components, it may be useful if different types of recycled material are used in these individual components.

This improves the sustainability of the polymer substrate or its entire product life cycle, as the use of at least one recycled material enables the sustainable production of counterfeit-proof polymer substrates and counterfeit-proof value documents or security documents. By using at least one recycled material in the production of polymer substrates, means are created which meet the increasing ecological requirements and at the same time guarantee the necessary counterfeit protection.

The alternative or additional use of at least one material made of renewable raw materials and/or biologically degradable and/or marine-degradable material may further improve the sustainable life cycle of the polymer substrate. It may also make a valuable contribution to environmental protection. The material made of renewable raw materials or the biologically degradable and/or marine-degradable material may be a material other than the recycled material. However, it is particularly sustainable if the material made of renewable raw materials or the biologically degradable and/or marine-degradable material is the same material as the recycled material.

According to an advantageous further development, it may be provided that the polymer substrate comprises at least 10%, preferably at least 20%, particularly preferably at least 30%, in particular at least 50% of the at least one recycled material and/or the at least one material made of renewable raw materials and/or the at least one biologically degradable and/or marine-degradable material, or that the polymer substrate comprises at least 10%, preferably at least 20%, particularly preferably at least 30%, in particular at least 50% of several recycled materials and/or several materials made of renewable raw materials and/or several biologically degradable and/or marine-degradable materials.

In particular, it may be advantageous if the at least one recycled material, and/or the at least one material made of renewable raw materials, and/or the at least one biologically degradable and/or marine-degradable material is a cellulose fiber free material.

Further it may be provided that the at least one recycled material and/or the at least one biologically degradable and/or marine-degradable material comprises a chemically recycled plastic and/or a mechanically recycled plastic, in particular comprises a translucent recycled plastic, wherein the at least one recycled material and/or the at least one biologically degradable and/or marine-degradable material preferably comprises at least one material from the group consisting of polyimide (PI), polypropylene (PP), monoaxially oriented polypropylene (MOPP) biaxially oriented polypropylene (BOPP), polyethylene (PE), polyphenylene sulfide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF), ethylene tetrafluoroethylene hexafluoropropylene fluorterpolymer (EFEP), cellulose- or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or mixtures and/or co-polymers and/or composites of these materials or is made from at least one of these materials.

In addition, it may be provided that the polymer substrate comprises a security element according to any of the claims.

The present disclosure also relates to a value document or security document which comprises at least one recycled material, and/or at least one material made of renewable raw materials, and/or at least one biologically degradable and/or marine-degradable material, wherein the at least one recycled material, and/or the at least one material made of renewable raw materials, and/or the at least one biologically degradable and/or marine-degradable material is a cellulose fiber free material.

The at least one recycled material, the at least one material made of renewable raw materials or the at least one biologically degradable and/or marine-degradable material may, for example, be contained in individual or several components such as layers, films, substrates or the like.

The at least one recycled material may be any type of recyclable material or material composition. For example, this includes any type of plastic, as well as metals, metal alloys or metal compounds. Various chemical compositions may also be recyclable and thus be included in the security element as recycled material. Because value documents or security documents are usually made up of several layers, films or components, it may be useful if different types of recycled material are used in these individual components.

This improves the sustainability of the value document or security document or its entire product life cycle, since the use of at least one recycled material enables the sustainable production of counterfeit-proof value or security documents, in particular banknotes. By using at least one recycled material, a product is created that meets the increasing ecological requirements and at the same time guarantees the necessary counterfeit protection.

The sustainable life cycle of the security document may be further improved by the alternative or additional use of at least one material made of renewable raw materials and/or biologically degradable and/or marine-degradable material. It may also make a valuable contribution to environmental protection. The material made of renewable raw materials or the biologically degradable and/or marine-degradable material may be a material other than the recycled material. However, it is particularly sustainable if the material made of renewable raw materials or the biologically degradable and/or marine-degradable material is the same material as the recycled material.

According to a further embodiment it may be conceivable that the value document or security document comprises at least 10%, preferably at least 20%, particularly preferably at least 30%, in particular at least 50% of the at least one recycled material and/or the at least one material made of renewable raw materials and/or the at least one biologically degradable and/or marine-degradable material, or that the value document or security document comprises at least 20%, particularly preferably at least 30%, in particular at least 50% of several recycled materials and/or several materials made of renewable raw materials and/or several biologically degradable and/or marine-degradable materials.

Furthermore, it may be expedient if the value document or security document comprises a security element according to any of the claims.

In addition, it may also be provided that the value document or security document is a polymer value document or polymer security document comprising a polymer substrate according to any of the claims.

If the value document or security document comprises at least one material made of renewable raw materials and/or if the value document or security document is biologically degradable and/or marine-degradable, the use of biaxially oriented polypropylene (BOPP) made from renewable raw materials has proven to be advantageous for the production of polymer banknotes, for example.

### BRIEF DESCRIPTION OF THE DRAWINGS

For the purpose of better understanding of the invention, this will be elucidated in more detail by means of the figures below.

These show respectively in a very simplified schematic representation:

FIG. 1 a cellulose fiber based banknote with a security element in plan view,

FIG. 2 a cellulose fiber based banknote from FIG. 1 in sectional view,

FIG. 3 a polymer banknote with a polymer substrate and two security elements in sectional view,

FIG. 4 an exemplary embodiment of a security element with a color shifting thin layer structure in sectional view,

FIG. 5 another exemplary embodiment of a security element with an optically variable embossing in sectional view.

### DETAILED DESCRIPTION OF EXEMPLARY EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

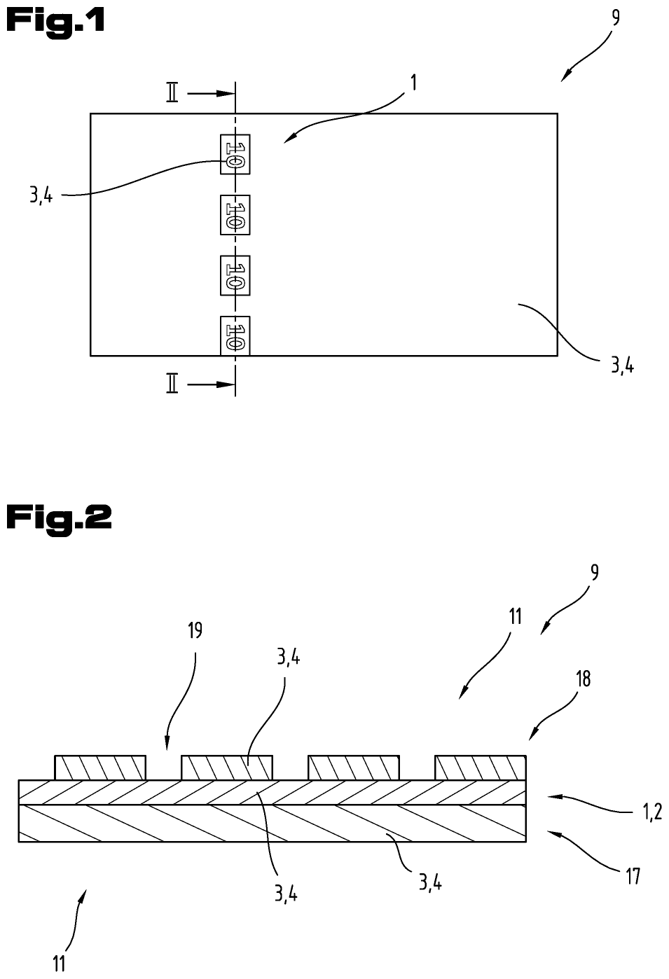

FIGS. 1 to 3 are described below largely in a synopsis to avoid unnecessary repetition.

FIGS. 1 and 2 show an embodiment of a security document in the special embodiment of a paper banknote 9 in plan view and in side sectional view.

The paper banknote 9 comprises at least one recycled material 3, and/or at least one material made of renewable raw materials, and/or at least one biologically degradable and/or marine-degradable material 4, wherein the at least one recycled material 3, and/or the at least one material of from renewable raw materials, and/or the at least one biologically degradable and/or marine-degradable material 4 is a cellulose fiber free material.

The paper banknote 9 comprises essentially a cellulose fiber based substrate 17 and a security element 1, configured as a security thread, in particular a window thread. It is provided that the security element 1 comprises at least one recycled material 3 and/or at least one material made of renewable raw materials and/or at least one biologically degradable and/or marine-degradable material 4. It may also be provided that the cellulose fiber based substrate 17 comprises at least one recycled material 3 and/or at least one material made of renewable raw materials and/or at least one biologically degradable and/or marine-degradable material 4.

The security element 1 is arranged on the cellulose fiber based substrate 17. But the security element 1 could also be embedded in this. In addition, the security element 1 may be at least partially covered over by a layer 18, as may be seen in FIG. 2. Those areas or recesses of the security element 1 or of the security feature 2 that are not covered or covered over by the layer 18 are perceptible to an observer as so-called windows 19 of the window thread. The layer 18 may be for example a protective varnish, a scratch-resistant film, a functional layer or something similar. The layer 18 may also be a security element 1, and the layer 18 may also comprise a recycled material 3 and/or at least one material made of renewable raw materials and/or at least one biologically degradable and/or marine-degradable material 4. The layer 18 may also be part of or comprise the cellulose fiber based substrate 17. It may also be provided that the layer 18 is or comprises a cellulose fiber based material.

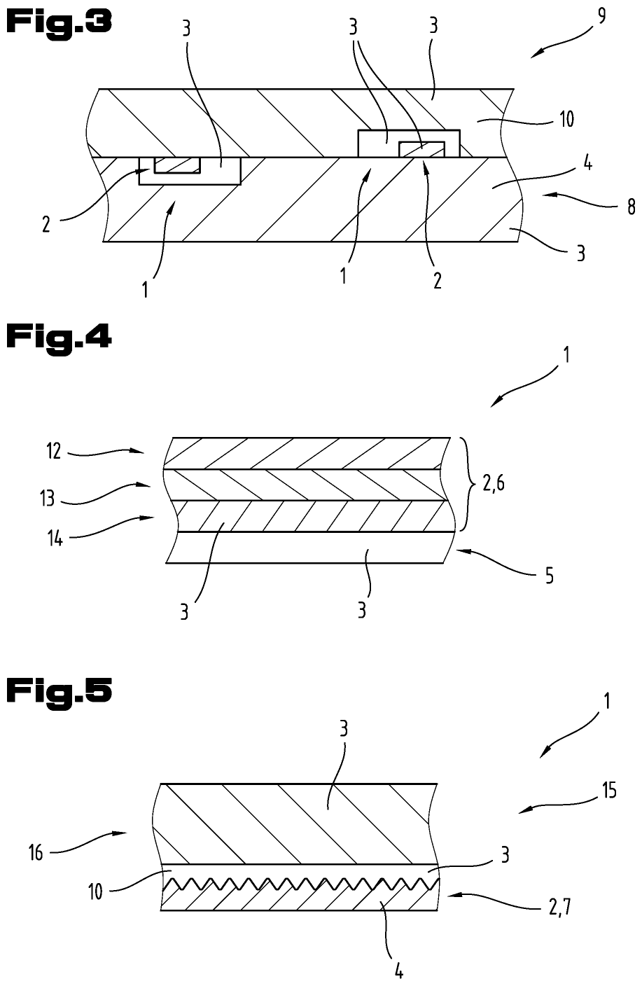

FIG. 3 shows a value document or security document in the specific embodiment of a polymer banknote 9 in side sectional view. The polymer banknote 9 essentially comprises a polymer substrate 8 and two security elements 1. It is provided that the polymer banknote 9 comprises at least one recycled material 3. On the polymer substrate 8 and the two security elements 1 a protective layer 10 is arranged, which may be transparent or at least translucent. The recycled material 3, such as a recycled paint or recycled paint components, may for example be included in the protective layer 10.

It goes without saying that the depiction of the figures is only to be interpreted roughly. The two security elements 1 in FIG. 3 are depicted with a rectangular cross-section, wherein the skilled person is of course aware of a large number of possible special embodiments, which will not be discussed in detail here. According to the example in FIG. 1, each of the two security elements 1 has a security feature 2, wherein these are also only schematically depicted. Of course, a security element 1 may also have several similar or different security features 2.

FIG. 3 shows security elements 1 embedded in the polymer substrate 8. In addition, security elements 1 may also be applied to the polymer substrate 8, directly or spaced by one or more intermediate layers. The polymer substrate 8 and also the security elements 1 may be covered or covered over by one or more further layers, partially or completely as shown. Of course, other layers such as protective varnishes, heat-sealing varnishes, adhesives, etc. may also be applied.

It has proven to be expedient that the value document or security document configured as a paper banknote according to FIGS. 1 and 2 9 or a polymer banknote 9 comprises at least 10%, preferably at least 20%, particularly preferably at least 30%, in particular at least 50% of the at least one recycled material 3 and/or the at least one material made of renewable raw materials and/or the at least one biologically degradable and/or marine-degradable material 4. However, it is also possible that the value document or security document comprises at least 20%, particularly preferably at least 30%, in particular at least 50% of several different recycled materials and/or several materials made of renewable raw materials and/or several biologically degradable and/or marine-degradable materials.

The security elements 1 shown in FIG. 3 comprise at least one recycled material 3. The recycled material 3 may be included both in the security feature 2 and in the basic structure of the security element 1. Furthermore, the polymer substrate 8 also comprises at least one recycled material 3. Of course, this does not have to be the same material. For example, the security element 1 may contain recycled aluminum, while the polymer substrate 8 is at least partially made of recycled plastic. The security elements 1, as well as the polymer substrate 8, may comprise at least 10%, preferably at least 20%, particularly preferably at least 30%, in particular at least 50% of the at least one recycled material 3.

The security elements 1 may comprise at least one material made of renewable raw materials. Alternatively or additionally, the security elements 1 may comprise at least one material made of renewable raw materials and/or at least one biologically degradable and/or marine-degradable material 4. These properties may also be advantageous for the polymer substrate 8. The material made of renewable raw materials or the biologically degradable and/or marine-degradable material 4 may in principle also be the same material as the recycled material 3. At least 10%, preferably at least 20%, particularly preferably at least 30%, in particular at least 50% of the at least one material may be comprised of renewable raw materials and/or the biologically degradable and/or marine-degradable material 4.

For this purpose, the at least one recycled material 3 or polymer substrate 8 comprised in the security elements 1, and/or the at least one material made of renewable raw materials, and/or the at least one biologically degradable and/or marine-degradable material 4 is a cellulose fiber free material.

The at least one recycled material 3 and/or the at least one biologically degradable and/or marine-degradable material 4 comprised in the security elements 1 or in the polymer substrate 8 may comprise a chemically recycled plastic and/or a mechanically recycled plastic. In particular, it may comprise a translucent recycled plastic, wherein the at least one recycled material 3 is preferably at least one of the materials selected from the group consisting of polyimide (PI), polypropylene (PP), monoaxially oriented polypropylene (MOPP), biaxially oriented polypropylene (BOPP), polyethylene (PE), polyphenylene sulphide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC), ethylene tetrafluoroethylene (ETFE), polytetrafluoroethylene (PTFE), polyvinyl fluoride (PVF), polyvinylidene fluoride (PVDF), ethylene tetrafluoroethylene hexafluoropropylene fluorterpolymer (EFEP), cellulose- or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or mixtures and/or co-polymers and/or composites of these materials or is made from at least one of these materials.

The at least one recycled material 3 and/or the at least one biologically degradable and/or marine-degradable material 4 may be at least one recycled metallic material, in particular selected from the group consisting of silver, copper, aluminum, gold, platinum, niobium, tin, or nickel, titanium, vanadium, chromium, cobalt and palladium or alloys of these materials, in particular cobalt-nickel alloys, and/or at least one highly refractive dielectric material with a refractive index greater than 1.65, in particular selected from the group consisting of zinc sulphide (ZnS), zinc oxide (ZnO), titanium dioxide (TiO2), carbon (C), indium oxide (In2O3), indium tin oxide (ITO), tantalum pentoxide (Ta2O5), cerium oxide (CeO2), yttrium oxide (Y2O3), europium oxide (Eu2O3), iron oxides such as iron (II,III) oxide (Fe3O4) and iron (III) oxide (Fe2O3), hafnium nitride (HfN), hafnium carbide (HfC), hafnium oxide (HfO2), lanthanum oxide (La2O3), magnesium oxide (MgO), neodymium oxide (Nd2O3), praseodymium oxide (Pr6O11), samarium oxide (Sm2O3), antimony trioxide (Sb2O3), silicon carbide (SIC), silicon nitride (Si3N4), silicon monoxide (SiO), selenium trioxide (Se2O3), tin oxide (SnO2), tungsten trioxide (WO3), comprise highly refractive organic monomers and/or highly refractive organic polymers or layers of metal oxides, such as non-stoichiometric aluminum oxide, copper oxides, or chromium oxides and/or be produced from at least one recycled metallic material from printing inks or varnishes with metallic pigments, in particular selected from the group of aluminum, silver, copper, gold, platinum, niobium, tin, or from nickel, titanium, vanadium, chromium, cobalt and palladium or alloys of these materials, in particular cobalt-nickel alloys.

The two security features 2 shown may be realized, for example, by an embossed layer, a partially metallized layer, a fluorescent layer, a printed layer, a magnetic coding and/or an optically variable and/or optically effective feature, in particular by a hologram and/or a color shifting coating, for example a coating comprising at least one color shifting thin layer element, and/or by features that are optically recognizable in transmission or reflection, machine-readable features and/or by electromagnetic wave-absorbing and/or re-emitting substances or features.

FIG. 4 shows an exemplary embodiment of a security element 1 with a security feature 2 in the special embodiment of a color shifting thin layer structure 6. To avoid unnecessary repetition, the same reference symbols are used for identical parts as in the previous FIG. 3. In addition, reference is made to the detailed description in the preceding FIG. 3 or only differences or special features of this exemplary embodiment are explained below.

The security element 1 shown in FIG. 4 is configured as a security thread, wherein an optically variable security feature 2, in particular a security feature 2, is configured with a color shifting thin layer structure 6. The color shifting thin layer structure 6 is shown in a simplified way and comprises essentially, according to the representation in FIG. 4 from top to bottom or from the visible side 11 or viewing side, an absorber layer 12, a distance layer 13 and a reflective layer 14. The reflective layer 14 is applied directly to a plastic film 5 in the function of a carrier film, as shown in the example in FIG. 4. Alternatively, it would also be conceivable that not the reflective layer 14, but the absorber layer 12 is applied to the plastic film 5. This is particularly conceivable if the plastic film 5 is a detachable carrier film and is removed or detached after the security element 1 has been applied to a banknote 9 for example. Recycled aluminum may be used as a component of the reflective layer 14 as a recycled material 3. The plastic film 5 comprises at least one recycled material 3. The illustration only shows a very simplified structure and, as already mentioned at the beginning, further additional layers and intermediate layers may also be provided. The plastic film 5 may preferably be configured as a PET film, which is produced with at least 50% PCR material.

FIG. 5 shows an exemplary embodiment of a security element 1 with a security feature 2 in the specific configuration of an optically variable embossing or with an embossing varnish 7. To avoid unnecessary repetition, the same reference symbols are used for identical parts as in the previous FIG. 3. In addition, reference is made to the detailed description in the preceding FIG. 3 or only differences or special features of this exemplary embodiment are explained below.

The security element 1 shown in FIG. 5 is configured as a transfer film 15 or as a transfer thread, wherein an optically variable security feature 2 is configured with an embossing varnish 7. The security element 1 is shown in a simplified way and comprises essentially, according to the representation in FIG. 5 from top to bottom or from the visible side 11 or viewing side, a removable or, after application, detachable carrier film 16, a protective layer 10 and an embossing varnish 7 with optically variable structures embossed therein. The protective layer 10 may preferably be transparent or at least translucent. The recycled material 3, such as a recycled paint or recycled paint components, may for example be included in the protective layer 10. The detachable carrier film 16 may be a plastic film 5 which comprises a recycled material 3. For example, the detachable carrier film 16 may be configured as a PET film with a proportion of PCR or PIR material. This illustration merely represents a highly simplified structure and—as already mentioned at the beginning—further additional layers and intermediate layers may also be provided. The embossing varnish 7 may be made with at least 20% acrylate monomers from renewable raw materials. For example, bio-based and biodegradable embossing varnishes 7 based on PLA may be used here.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present disclosure lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be taken from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

1. Security element for value documents or security documents with at least one security feature, wherein the security element comprises at least one recycled material, and/or at least one material made of renewable raw materials, and/or at least one biologically degradable and/or marine-degradable material.

2. Security element according to claim 1, wherein the security element comprises at least 10%, preferably at least 20%, particularly preferably at least 30%, in particular at least 50% of the at least one recycled material and/or of the at least one material made of renewable raw materials and/or of the at least one biologically degradable and/or marine-degradable material, or that the security element comprises at least 10%, preferably at least 20%, particularly preferably at least 30%, in particular at least 50% of several recycled materials and/or several materials made of renewable raw materials and/or several biologically degradable and/or marine-degradable materials.

3. Security element according to claim 1, wherein the at least one recycled material, and/or the at least one material made of renewable raw materials, and/or the at least one biologically degradable and/or marine-degradable material is a cellulose fiber free material.

4. Security element according to claim 1, wherein the security element is configured with at least one plastic film comprising the at least one recycled material and/or the at least one material made of renewable raw materials and/or the at least one biologically degradable and/or marine-degradable material.

5. Security element according to claim 1, wherein the at least one recycled material and/or the at least one biologically degradable and/or marine-degradable material comprises a chemically recycled plastic and/or a mechanically recycled plastic, in particular comprises a translucent recycled plastic, wherein the at least one recycled material and/or the at least one biologically degradable and/or marine-degradable material preferably comprises at least one of the materials selected from the group consisting of polyimide (PI), polypropylene (PP) monoaxially oriented polypropylene (MOPP), biaxially oriented polypropylene (BOPP), polyethylene (PE), polyphenylene sulfide (PPS), polyether ether ketone (PEEK), polyether ketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF), ethylene-tetrafluoroethylene-hexafluoropropylene fluorterpolymer (EFEP), cellulose or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or mixtures and/or co-polymers and/or composites of these materials or is made from at least one of these materials.

6. Security element according to claim 1, wherein the at least one recycled material and/or the at least one biologically degradable and/or marine-degradable material is at least one recycled metallic material, in particular selected from the group consisting of silver, copper, aluminum, gold, platinum, niobium, tin or nickel, titanium, vanadium, chromium, cobalt and palladium or alloys of these materials, in particular cobalt-nickel alloys, copper, aluminum, gold, platinum, niobium, tin, or nickel, titanium, vanadium, chromium, cobalt and palladium or alloys of these materials, in particular cobalt-nickel alloys, and/or at least one highly refractive dielectric material with a refractive index of greater than 1.65, in particular selected from the group zinc sulphide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides such as iron (II, III) oxide (Fe₃O₄) and iron (III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), high refractive index organic monomers and/or high refractive index organic polymers or layers of metal oxides, such as non-stoichiometric aluminum oxide, copper oxides, or chromium oxides and/or of at least one recycled metallic material from printing inks or varnishes with metallic pigments, in particular selected from the group consisting of aluminum, silver, copper, gold, platinum, niobium, tin, or nickel, titanium, vanadium, chromium, cobalt and palladium or alloys of these materials, in particular cobalt-nickel alloys.

7. Security element according to claim 1, wherein the at least one security feature is formed by an embossed layer, a partially metallized layer, a fluorescent layer, a printed layer, a magnetic coding and/or an optically variable and/or optically effective feature, in particular by a hologram and/or a color shifting coating, for example a coating comprising at least one color shifting thin layer element, and/or by features that are optically recognizable in transmission or reflection, machine-readable features and/or by electromagnetic wave-absorbing and/or re-emitting substances or features.

8. Security element according to claim 4, wherein the at least one security feature comprises an optically variable security feature, and in that the at least one plastic film comprises a PET film, which PET film is produced with at least 50% PCR material.

9. Security element according to claim 1, wherein the security element is produced with an optically variable embossing in an embossing varnish with at least 20% acrylate monomers from renewable raw materials.

10. Polymer substrate for the production of polymer value documents or polymer security documents or for the production of security elements, wherein the polymer substrate comprises at least one recycled material, and/or at least one material made of renewable raw materials, and/or at least one biologically degradable and/or marine-degradable material.

11. Polymer substrate according to claim 10, wherein the polymer substrate comprises at least 10%, preferably at least 20%, more preferably at least 30%, in particular at least 50% of the at least one recycled material and/or of the at least one material made of renewable raw materials and/or of the at least one biologically degradable and/or marine-degradable material, or that the polymer substrate comprises at least 20%, particularly preferably at least 30%, in particular at least 50% of several recycled materials and/or several materials made of renewable raw materials and/or several biologically degradable and/or marine-degradable materials.

12. Polymer substrate according to claim 10, wherein the at least one recycled material, and/or the at least one material made of renewable raw materials, and/or the at least one biologically degradable and/or marine-degradable material is a cellulose fiber free material.

13. Polymer substrate according to claim 10, wherein the at least one recycled material and/or the at least one biologically degradable and/or marine-degradable material comprises a chemically recycled plastic and/or a mechanically recycled plastic, in particular comprises a translucent recycled plastic, wherein the at least one recycled material and/or the at least one biologically degradable and/or marine-degradable material preferably comprises at least one material from the group consisting of polyimide (PI), polypropylene (PP), monoaxially oriented polypropylene (MOPP), biaxially oriented polypropylene (BOPP), polyethylene (PE), polyphenylene sulphide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile butadiene styrene (ABS), polyvinyl chloride (PVC), ethylene tetrafluoroethylene (ETFE), polytetrafluoroethylene (PTFE), polyvinyl fluoride (PVF), polyvinylidene fluoride (PVDF), ethylene-tetrafluoroethylene-hexafluoropropylene fluorterpolymer (EFEP), cellulose or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or mixtures and/or co-polymers and/or composites of these materials or is made from at least one of these materials.

14. Polymer substrate according to claim 10, wherein the polymer substrate comprises a security element for value documents or security documents with at least one security feature.

15. Value document or security document, wherein the value document or security document comprises at least one recycled material, and/or at least one material made of renewable raw materials, and/or at least one biologically degradable and/or marine-degradable material, wherein the at least one recycled material, and/or the at least one material made of renewable raw materials, and/or the at least one biologically degradable and/or marine-degradable material is a cellulose fiber free material.

16. Value document or security document according to claim 15, wherein the value document or security document comprises at least 10%, preferably at least 20%, particularly preferably at least 30%, in particular at least 50% of the at least one recycled material and/or the at least one material made of renewable raw materials and/or the at least one biologically degradable and/or marine-degradable material, or that the value document or security document comprises at least 20%, particularly preferably at least 30%, in particular at least 50% of several recycled materials and/or several materials made of renewable raw materials and/or several biologically degradable and/or marine-degradable materials.

17. Value document or security document according to claim 15, wherein the value document or security document comprises:
(a) a security element with at least one security feature comprising at least one recycled material, and/or at least one material made of renewable raw materials, and/or at least one biologically degradable and/or marine-degradable material; and/or
(b) a polymer value document or polymer security document comprising a polymer substrate for the production of security elements, the polymer substrate including at least one recycled material, and/or at least one material made of renewable raw materials, and/or at least one biologically degradable and/or marine-degradable material.
